(19) United States
(12) Patent Application Publication
(10) Pub. No.: US 2001/0023402 A1
(43) Pub. Date: Sep. 20, 2001

(54) System and method for transmitting and journaling a retail transaction

(76) Inventor: Tracy L. Flynn, Alpharetta, GA (US)

Correspondence Address: Paul W. Martin, NCR Corporation, Law Department, WHQ-5E, 1700 S. Patterson Boulevard, Dayton, OH, 45479, US

(21) Appl. No.: 09/858,968

(22) Filed: May 16, 2001

Related U.S. Application Data
(63) Continuation of application No. 09/099,659, filed on Jun. 17, 1998.
(60) Provisional application No. 60/056,114, filed on Aug. 20, 1997.

(51) Int. Cl. G06F 17/60

(52) U.S. Cl. 705/1

(57) ABSTRACT

A system and method for allowing consumers to track their purchases in detail. The system and method comprises of an input means for entering data, a transaction buffer, a means for storing product information from the input means into the transaction buffer, means for storing personal information including an address from the input means into the transaction buffer and a processing means performing the steps of storing product information in the transaction buffer for each product in the retail transaction, storing personal information in the transaction buffer, formatting the product information for each product in the retail transaction, and transmitting the product information for each product in the retail transaction to the designated address.

### CROSS REFERENCE TO RELATED INVENTION

The present patent application is a continuation of U.S. Provisional patent application Ser. No. 60/056,114, entitled “System and Method for Transmitting and Journaling a Retail Transaction”, filed on Aug. 20, 1997.

### BACKGROUND OF THE INVENTION

1. Field of the Invention

The present invention generally relates to a system and method for transmitting and journaling a retail transaction to a designated address.

2. Description of the Prior Art

Retail establishments today provide customers a printed receipt of their transaction. The information on the printed receipt usually contains the name of the store, the date, the items purchased, the price of each item purchased, the total amount, and the amount paid by the customer. Although this information is kept by the retail establishment, it is not provided to the customer in a useable electronic format. Likewise, if the customer paid with a credit, debit or check, the consumer receives a record of the transaction in their credit card statement, bank statement, or canceled check. Again, however, this information is not provided to the customer in a useable electronic format.

Retail transaction information in an electronic format can be used by consumers in several ways: to update personal finance management software, to update personal shopping list software, to update product registration and warranty software and to use with data warehouse exchange software.

Updating personal finance management software such as Intuit's Quicken consists of manually entering and posting transactions. This can be done using receipts or credit/debit card statements. The manual transaction entry does not usually include detailed information on the purchase. The consumer may categorize the purchase and may include a comment which might contain additional information. For example, a consumer may categorize a purchase of twenty plus (20+) items from a grocery store as groceries. The actual transaction, though, is likely to be made of individual items from different departments within the grocery store, such as, grocery items, meat items, produce items, and floral items.

Furthermore, in prior art systems, making a shopping lists for replenishment goods is a manual process of checking what is needed in the home prior to making a visit to the local store. This process may include simply using your best recollection of what is needed before going to the store or it may be a matter of allowing the physical presence of a product in the store serve as a reminder of the items needed. In most cases, this could be automated if detailed historic consumer purchase data were available.

Shopping information could be tracked by any individual retailer to help the consumer in the production of a list. This however, would only be reflective of items purchased within that retail store. It has been observed that loyalty among consumers is declining so it is unlikely that an accurate list could be made from any one retailer's history. If the consumer were to buy milk occasionally at a local convenience store rather than the usual grocery store, the process for calculating the replenishment list by the retailer would not be reflective of this off-premise purchase.

With detailed data individual items purchased across any number of retail locations, the consumer shopping list application could be maintained regardless of the number of stores visited. This list could be provided to the consumer at any time to help with the chore of shopping in a store. In the electronic shopping example, the consumer could simply review the list prior to sending to his/her retailer for replenishment of the items on the list. Unfortunately, until now, the functionality described above was not available.

### SUMMARY OF THE INVENTION

This invention addresses the need of consumers to track detail information of their purchases by automatically providing customers detailed electronic journals of their purchases for consumer based applications. The automatic journaling is created from the point-of-sale transaction data. This data is routed to a consumer for posting to various consumer applications.

According to the teaching of the present invention, at a traditional retail point-of-sale terminal, a consumer identifies himself with routing information such as an e-mail address, etc. The routing information may be provided in the form of encoded data such as a bar code or magnetic strip that would contain the e-mail address of the consumer. The e-mail address of the consumer along with detail information on the items purchased is added to a transaction buffer.

The point-of-sale terminal is connected to an in-store processor that consolidates information from multiple cash registers and provides a gateway to a wide area network. In the preferred embodiment the in-store processor sends the transaction data from multiple cash registers to a processor at the central office. Either the in-store processor or the processor at the central would then route the detailed information of each transaction to the respective customer via their e-mail address.

Once routed to the consumer's destination computer, the e-mail is placed in the “inbox” for the consumer to read. The e-mail provides the consumer with information regarding the source of the mail message and detail information regarding the transaction. The detailed information may be used to update any consumer based application such as finance management software, automated shopping lists, automatic registration of products for warranty and returns and the creation of a personal data warehouse.

### BRIEF DESCRIPTION OF THE DRAWINGS

FIG. 1 is a diagram showing the overall setup for the invention.

FIGS. 2a-2c are a flowchart depicting the overall flow of the invention.

FIG. 3 is a flowchart depicting various ways that the invention may be used.

### DETAILED DESCRIPTION OF THE INVENTION

### 1. Overview of the Customer Journaling Invention

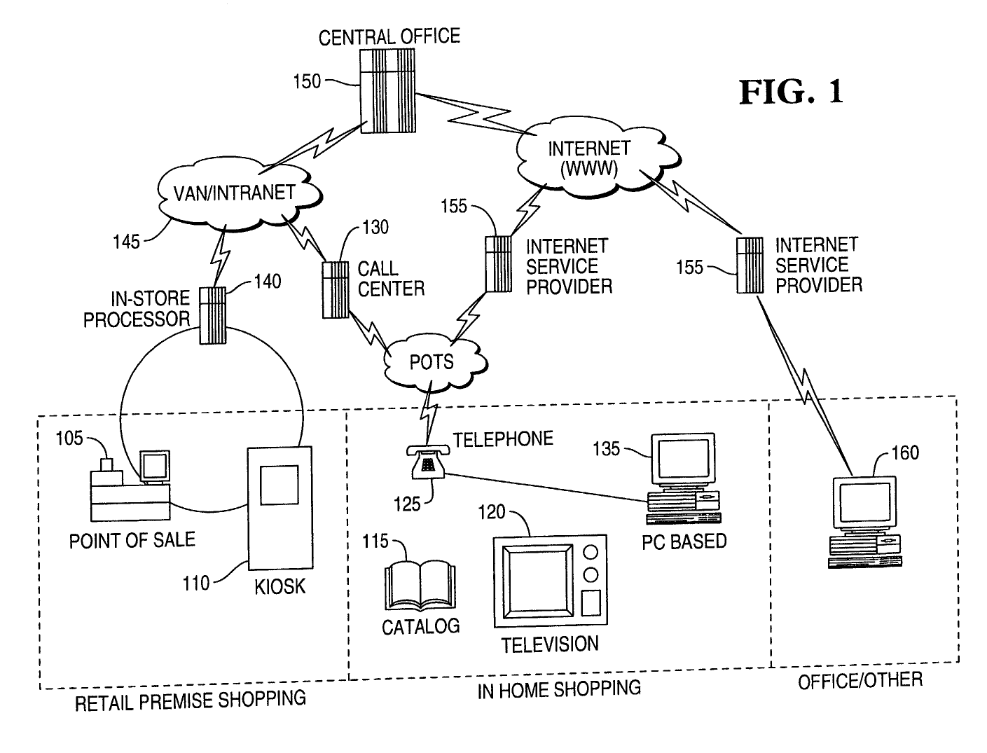

Referring to FIG. 1, detailed transaction data is generated by a point-of-sale device. Point-of-sale devices can exist in many forms. The traditional point-of-sale is the cash register 105 found at a retail location which includes a scanner and a keyboard, etc. Scanners may include hand-held retail scanners such as NCR model numbers 7835, 7836, and 7890. Keyboards may include any retail keyboard. The point-of-sale function could also be a kiosk 110.

In addition to these point-of-sales locations, non-store retailing has developed other point-of-sale devices. With catalog 115 and television 120 based home shopping, the phone 125 is the consumer's interface to the point-of-sale, the point-of-sale being a call center 130 managed by a retailer. With the advent of commercial online services and the internet, a PC 135 may also serve as the point-of-sale while online to the retail service.

In the case of the traditional cash register 105 and the kiosk 110 these systems are generally connected to an in-store processor 140 at the retail location. In the preferred embodiment, the in-store processor 140 sends the information from multiple cash registers 105 to the central office 150. This processor 140 consolidates information from multiple cash registers 105 and/or kiosk 110 and provides a gateway to a wide area network 145. The key interface for this gateway is the retailer's central office 150. Often this central office provides consolidation of store level data for management review. It also can provide a gateway for the stores to common credit/debit authorization networks. The consumers interface and record of this transaction is typically the printed receipt from the cash register or kiosk.

In the in-home shopping environment the consumer is provided some mechanism to browse products. Catalog retailing 115 provides the physical catalog which contains product information and pricing. TV based retailing 120 provides a broadcast of product information and pricing on which a consumer can make a purchase decision. In the case of PC based shopping 135 the consumer typically is provided and “electronic” catalog. Interfacing to the retailer is done through the use of an online service provider or through an Internet Service Provider 155.

In this case, much of the information communicated between the consumer and the retailer is similar to the information provided in the catalog retailing 115 example, but it is provided using the electronic media.

In the case of catalog 115 and TV shopping 120 the consumer places a call most often to the retailers call center 130. The call center 130 can itemize the order add shipping charges and provide the consumer with an estimated shipment date for the product. Confirmation of the details of the order are generally contained in the shipment of merchandise to the consumer. The consumer also would see a summary of the purchase (total amount only) on their credit card statement (assuming they paid with a credit card). In the case of PC 135 based shopping, the consumer is typically provided with total purchase amount and estimated ship date. The retailer using this interface can also provide a detailed account of the transaction via e-mail back to the consumer using the PC 135.

The non-store retailing example can also be accomplished outside of the consumers home. As PC 160 access in the office and home becomes prevalent, shopping via a PC 160 will increase.

### 2. Overall Control Flow of Invention

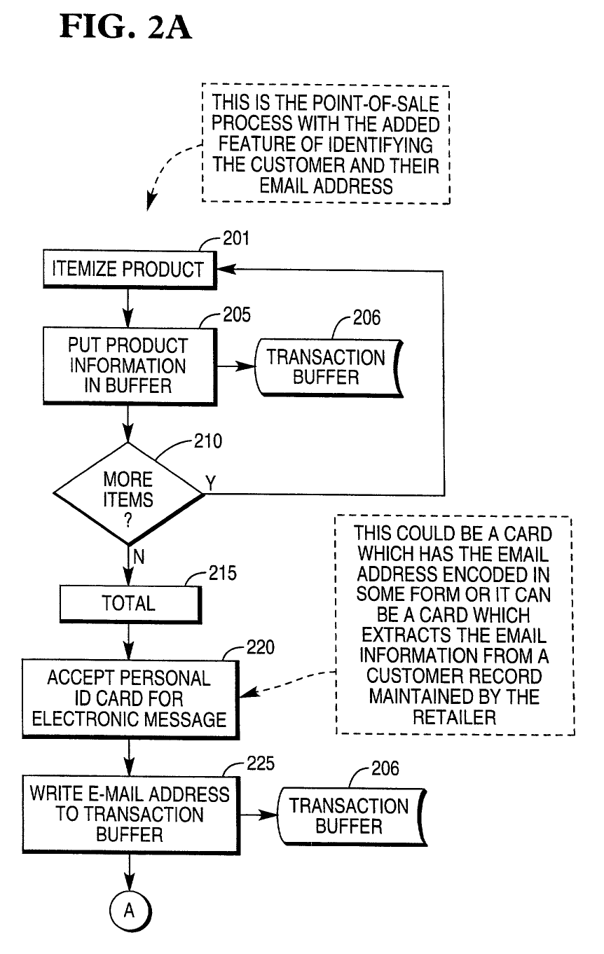

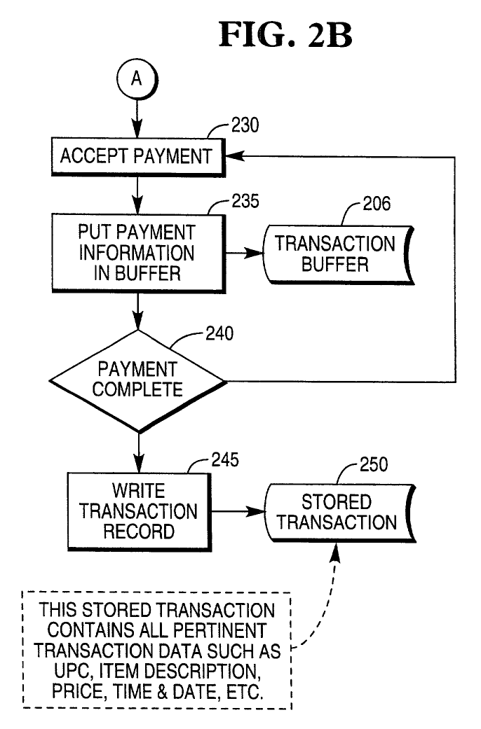

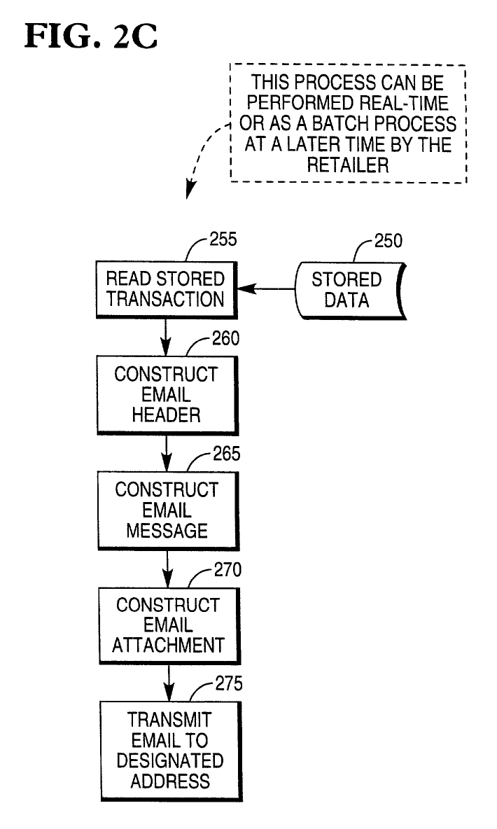

Referring to FIGS. 2A-2C, the traditional retail transaction includes the itemization 201 of one or more products that are being purchased. Itemization typically includes either the entering of a price manually on a keyboard in a point-of-sale store, scanning a bar coded item, or the selection of an item from a menu in a self service environment such as on-line shopping or kiosk retailing. This itemization step 201 includes multiple data elements for the item such as the price, description, and itemization of the items for tax and food stamps. The itemization step 201 is performed by the scanning or key entering of the bar code for the item. In the preferred embodiment the bar code is in the format of the Universal Product Code (UPC). The UPC is an 11-digit number that uniquely identifies a purchase item. The UPC contains information on the type of item, manufacturer of the item, size of the item and price.

The itemization step 201 is followed by the storing 205 of the item information in a buffer 206 which will accumulate the transaction item detail so that the transaction can be completed. In the preferred embodiment, buffer 206 may be random access memory (RAM) within a point-of-sale terminal 105, or equivalent. Additional items in the transaction continue through steps 210, 201, and 205 until there are no more items to be itemized.

Next, the transaction is totaled at step 215. This step includes totaling the price of each of the items in the transaction. It also includes the calculation of all appropriate taxes for the transaction based on the items itemized for tax in the transaction. This total may also include any fees associated with the transaction such as delivery or shipping.

At step 220, the consumer identifies himself to the point-of-sale system through several mechanisms. This may include a mechanism such as a credit/debit card, frequent buyer card, smart card, or biometric signature which uniquely identifies the customer. The card which identifies the customer may explicitly use the customer's electronic mail address as an identifier or may access a file which contains customer data and retrieve the customer's unique e-mail address.

In step 225, the e-mail address is combined with the transaction data in the transaction buffer 206. The customer pays for the transaction at step 230. Payment may be made with cash, credit, debit, check, pre-paid card, stored value card or other form of payment. At step 235, the payment information is combined with the transaction data in the transaction buffer 206. If the initial payment is not complete (i.e. payment does not cover the total amount of the transaction) additional payment can be accepted. If payment is complete, then any change back is calculated for the customer.

At step 245, after payment is complete, the transaction buffer is saved to a memory device such as disk or solid state memory with, for example, the point-of-sale terminal 105. The stored transaction 250 now contains all pertinent data such as UPC, item description, price, time and date, total amount, and total paid.

At step 255 the stored transaction 250 is read by the processing means (in the in-store processor 140). In the preferred embodiment, the processing means constructs an electronic mail header at step 260, an electronic mail message 265, with an electronic mail attachment at step 270 which is the stored transaction 250. At step 275, the electronic mail message along with the attachment is transmitted through a network and routed to the destination e-mail address acquired from step 220.

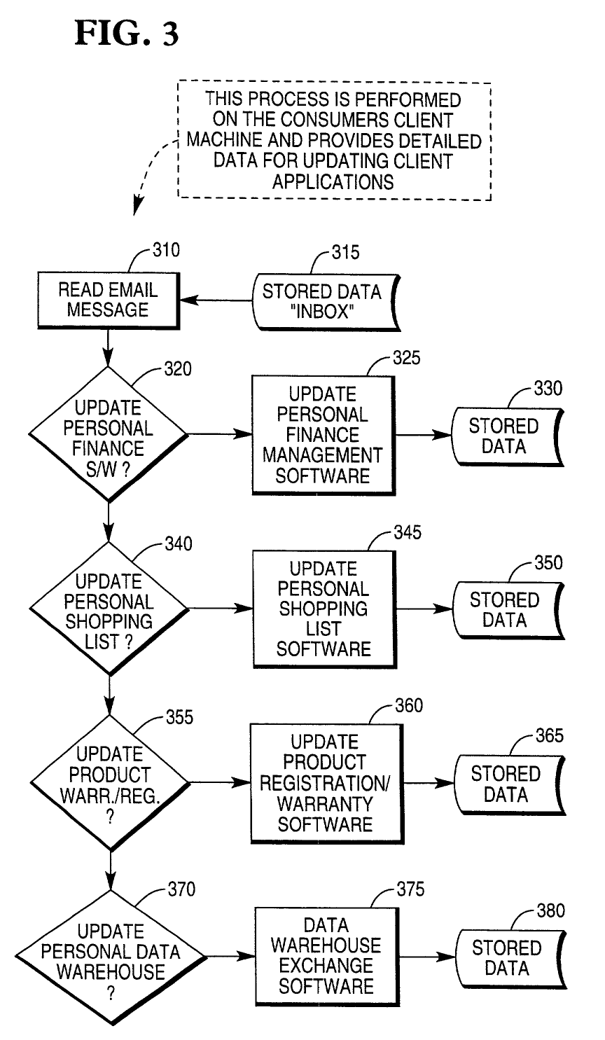

Referring to FIG. 3, once routed to the destination computer, the e-mail is placed in the “inbox” 315 for the consumer to read at step 310. The e-mail provides the consumer with information regarding the source of the mail message and detail information on the transaction. The detail information may be used to update any of a variety of consumer based applications, as previously described.

For example, the detailed transaction can be used with finance management software 320 to automatically post the retail transaction. Previously, this required the consumer to manually enter information such as the store name, the amount of the transaction, and perhaps a category for the purchase. This information can now be automatically posted as a result of the attached transaction information created in step 245. Also, since additional detail is now available, the personal finance manager can now track more detail about each purchase as the transaction can be stored in the native format of the personal management software at step 330.

Since the transmitted transaction has detailed item information, the consumer can use the information to created automated shopping lists 340. By automatically capturing detailed transaction data repetitively, a consumer consumption behavior could be modeled which would allow an application to “predict” when the purchase of an item is needed. For example, if all or most consumer purchases were recorded, stored, and transmitted as described in steps 201-275, a software application could easily identify the replenishment cycles associated with types or purchases such as milk, bread, or other staples. These items could be identified in detail as a result of using the UPC code or description associated with the item. The transmitted data may be stored to accumulate patterns of consumer consumption.

The collection of detailed purchase information described in steps 201-275 by the consumer can be used to facilitate other applications such as the automatic registration of products for warranty and returns in step 355. Product purchase information such as date and retailer are included in the detailed transaction data. Warranty registration could be facilitated through the automatic distribution of this data to the consumer in electronic form. This data could then be forwarded with additional consumer information to the manufacturer of a specific product for the registration of the product for warranty. This detail data can also be used to reconstruct receipts for returning merchandise to the retailer since the detailed data includes information that would allow the retailer to verify the purchase date and retailer of the original retail transaction.

The collection of detailed transaction data over time could be used to create a personal data warehouse 370. An application could then use this personal data warehouse to exchange on a selected basis information on past purchase behavior to remote agents or processes. The agent may reside on the consumer's device which negotiates with a retailer's computer agent for the data. Detailed consumer data is of great value to a retailer in that this additional data can help the retailer more effectively market products to the consumer based on past experiences of the consumer. For example, currently, the retailer only views consumer data that the consumer purchased at that store and only if the consumer has identified himself in such a way that allows the retailer to track the purchase to a particular consumer. This invention allows the retailer to have an added dimension to the consumer in the form of information relating to purchases made at other retailers which have been stored in the personal data warehouse. The consumer's agent could negotiate the value of the data with the retailer's agent based on the amount of data in the warehouse and the value placed on the information by the retailer. Of course, all of this may be under the consumer's control so that the consumer decides what information to disclose to the retailer and at what price.

Although the present invention has been described with particular reference to certain preferred embodiments thereof, variations and modifications of the present invention can be effected within the spirit and scope of the following claims.

What is claimed is:

1. A system for transmitting and journaling retail transactions to a consumer, comprising:
(a) input means for receiving retail transaction data, wherein the retail transaction data includes product information associated with a product purchased by the consumer and a selected electronic address associated with the consumer;
(b) a transaction buffer;
(c) first processing means coupled to the input means and the transaction buffer, the processing means performing the steps of:
(i) storing the product information in the transaction buffer;
(ii) storing the selected electronic address in the transaction buffer;
(iii) transmitting the product information in the retail transaction to the selected electronic address.

2. The system of claim 1, wherein the product information comprises the Universal Product Code (UPC) for the product.

3. The system of claim 1, wherein the product information is selected from the list of: product price, product description, product manufacturer, and product size.

4. The system of claim 1, wherein the input means is a scanner.

5. The system of claim 1, wherein the input means is a keyboard.

6. The system of claim 1, further comprising:
(d) second processing means at the selected electronic address for receiving the product information from the first processing means, and for automatically registering warranty information for the associated product.

7. The system of claim 1, further comprising:
(d) second processing means at the selected electronic address for receiving the product information from the first processing means, and for adding the product information to a shopping list for use by the consumer.

8. The system of claim 1, further comprising:
(d) second processing means at the selected electronic address for receiving the product information from the first processing means, and for further processing the product information.

9. The system of claim 8, wherein the second processing means performs the steps of:
(i) loading the product information into a personal financial management software application; and
(ii) processing the product information by the personal financial management software application.

10. A process for transmitting and journaling retail transactions to a consumer, comprising the steps of:
(a) receiving retail transaction data during a retail transaction, wherein the retail transaction data includes product information associated with a product purchased by the consumer and a selected electronic address associated with the consumer;
(b) storing the product information in a transaction buffer;
(c) storing the selected electronic address in the transaction buffer;
(d) transmitting the product information in the retail transaction to the selected electronic address.

11. The process of claim 10, further comprising the step of:
(e) receiving the product information from the first processing means at the selected electronic address, and automatically registering warranty information for the associated product.

12. The process of claim 10, further comprising the steps of:
(e) receiving the product information from the first processing means at the selected electronic address, and adding the product information to a shopping list for use by the consumer.

13. The system of claim 10, further comprising the steps of:
(e) receiving the product information at the selected electronic address; and
(f) further processing the product information.

14. The system of claim 10, further comprising the steps of:
(e) receiving the product information at the selected electronic address; and
(f) loading the product information into a personal financial management software application for further processing.
